(19) United States
(12) Patent Application Publication
(10) Pub. No.: US 2014/0305000 A1
(43) Pub. Date: Oct. 16, 2014

(54) Systems and Methods For Dewatering Mine Tailings With Water-Absorbing Polymers

(71) Applicants: Wei Ren, Missouri City, TX (US); Ken N. Sury, Calgary, CA (US); Paul L. Tanaka, Sugar Land, TX (US); David C. Rennard, Houston, TX (US); Scott R. Clingman, Houston, TX (US); Thomas R. Palmer, Lima, NY (US)

(72) Inventors: Wei Ren, Missouri City, TX (US); Ken N. Sury, Calgary, CA (US); Paul L. Tanaka, Sugar Land, TX (US); David C. Rennard, Houston, TX (US); Scott R. Clingman, Houston, TX (US); Thomas R. Palmer, Lima, NY (US)

(21) Appl. No.: 14/206,556

(22) Filed: Mar. 12, 2014

(30) Foreign Application Priority Data
Apr. 10, 2013 (CA) 2812271

(51) Int. Cl. F26B 5/16

(52) U.S. Cl. CPC F26B 5/16
USPC 34/353; 34/95.1

(57) ABSTRACT

Systems and methods for dewatering mine tailings with water-absorbing polymers. The systems and methods may include combining a mine tailings slurry, which includes mine tailings and water, with a water-absorbing polymer. The water-absorbing polymer may absorb water from the mine tailings, thereby increasing a solids content of the mine tailings. The mine tailings may be combined with the water-absorbing polymer prior to, during, and/or subsequent to transfer of the mine tailings to a mine tailings dewatering and/or disposal site. In some embodiments, the water-absorbing polymer may be an encapsulated water-absorbing polymer.

### CROSS REFERENCE TO RELATED APPLICATIONS

This application claims the priority benefit of Canadian Patent Application 2,812,271 filed Apr. 10, 2013 entitled SYSTEMS AND METHODS FOR DEWATERING MINE TAILINGS WITH WATER-ABSORBING POLYMERS, the entirety of which is incorporated by reference herein.

### FIELD OF THE DISCLOSURE

The present disclosure is directed to systems and methods for dewatering mine tailings with water-absorbing polymers.

### BACKGROUND OF THE DISCLOSURE

Mining operations, including mining operations that remove bitumen from oil sands, generate a waste stream that may be referred to generally as mine tailings. These mine tailings often may include a significant quantity of water and may be stored in a storage facility, or structure, such as an enclosure, or pond. Over time, particles within the stored mine tailings may settle, producing a relatively stable suspension of the particles in the water that may have a solids content of approximately 30 wt %. This suspension may be referred to herein as mature fine tailings (MFT) and has a very low shear strength. Thus, the MFT cannot be built upon and vegetation often may not grow thereon.

Because of the long dewatering time for the MFT and the high rate at which mine tailings may be generated, large volumes of mine tailings have been, and continue to be, generated in various parts of the world. Environmental concerns, space constraints, and/or government regulations may dictate that these mine tailings be processed to a more stable form, thereby permitting reclamation of the storage facility, revegetation of the mine tailings, and/or further/other use of the storage facility. As an illustrative, non-exclusive example, Canadian Directive 74 requires that stored mine tailings be processed such that they have a shear strength of at least 5 kilopascals (kPa) within one year of storage and a shear strength of at least 10 kPa within 5 years of storage. Meeting this directive, for example, may require dewatering of the stored mine tailings at a rate that is significantly higher than the dewatering rates that are experienced when the mine tailings are simply placed in the storage facility and allowed to dewater naturally.

Several technologies have been developed that may increase the dewatering rate of the stored mine tailings; however, these technologies often are costly to implement, require large amounts of space, and/or are ineffective at reaching a target shear strength within a desired period of time, such as to keep up with the rate at which additional mine tailings are being generated and/or to meet the government regulations. Thus, there exists a need for improved systems and methods for dewatering mine tailings.

### SUMMARY OF THE DISCLOSURE

Systems and methods for dewatering mine tailings with water-absorbing polymers. In some embodiments, the systems and methods may include combining a mine tailings slurry, which includes mine tailings and water, with a water-absorbing polymer. In some embodiments, the combining includes combining the mine tailings slurry with the water-absorbing polymer to produce an augmented mine tailings slurry.

The mine tailings may be combined with the water-absorbing polymer prior to, during, and/or subsequent to transfer of the mine tailings to a mine tailings dewatering site and/or to a mine tailings disposal site. In some embodiments, the combining includes combining the mine tailings slurry with the water-absorbing polymer within a mixing vessel, such as a thickening assembly. In some embodiments the combining includes combining the mine tailings slurry with the water-absorbing polymer within a transfer pipe. In some embodiments, the combining includes combining the mine tailings slurry with the water-absorbing polymer at the mine tailings dewatering site.

In some embodiments, the systems and methods include piping the augmented mine tailings slurry to the mine tailings dewatering site and distributing the augmented mine tailings slurry within the mine tailings dewatering site. In some embodiments, the systems and methods further include initiating water absorption by the water-absorbing polymer subsequent to the piping.

In some embodiments, the systems and methods include distributing the mine tailings slurry within the mine tailings dewatering site and mechanically incorporating the water-absorbing polymer into the mine tailings. In some embodiments, the systems and methods include waiting at least a threshold settling time subsequent to distributing the mine tailings within the mine tailings dewatering site and prior to the mechanically incorporating.

In some embodiments, the systems and methods include absorbing water from the mine tailings with the water-absorbing polymer to generate a swollen water-absorbing polymer and a dewatered mine tailings slurry. In some embodiments, the systems and methods further include reusing, recycling, and/or reclaiming at least a portion of the water-absorbing polymer by separating the swollen water-absorbing polymer from the dewatered mine tailings slurry. In some embodiments, the systems and methods further may include reclaiming at least a portion of the water from the swollen water-absorbing polymer and optionally may include reusing and/or recycling at least a portion of the reclaimed water.

In some embodiments, the water-absorbing polymer may be encapsulated in a coating material to form an encapsulated water-absorbing polymer. The coating material, when utilized, fluidly isolates the water-absorbing polymer from the water that is contained within the mine tailings slurry for at least a threshold isolation time subsequent to fluid contact between the water and the encapsulated water-absorbing polymer. In some such embodiments, the systems and methods may include selecting the coating material and/or a thickness of the coating material that encapsulates the water-absorbing polymer, such as to regulate, or define, the threshold isolation time. In some embodiments, the selecting additionally or alternatively includes selecting such that a ratio of a density of the encapsulated water-absorbing polymer to a density of the mine tailings slurry is less than a threshold value, or a threshold density ratio.

### BRIEF DESCRIPTION OF THE DRAWINGS

FIG. 1 is a schematic representation of illustrative, non-exclusive examples of mining operations that may include and/or utilize the systems and methods according to the present disclosure.

FIG. 2 is a flowchart depicting methods according to the present disclosure of dewatering mine tailings.

FIG. 3 is a flowchart depicting additional methods according to the present disclosure of dewatering mine tailings.

FIG. 4 is a flowchart depicting methods of forming an encapsulated water-absorbing polymer according to the present disclosure.

FIG. 5 is a flowchart depicting methods according to the present disclosure of reclaiming, reusing, and/or recycling a water-absorbing polymer.

### DETAILED DESCRIPTION AND BEST MODE OF THE DISCLOSURE

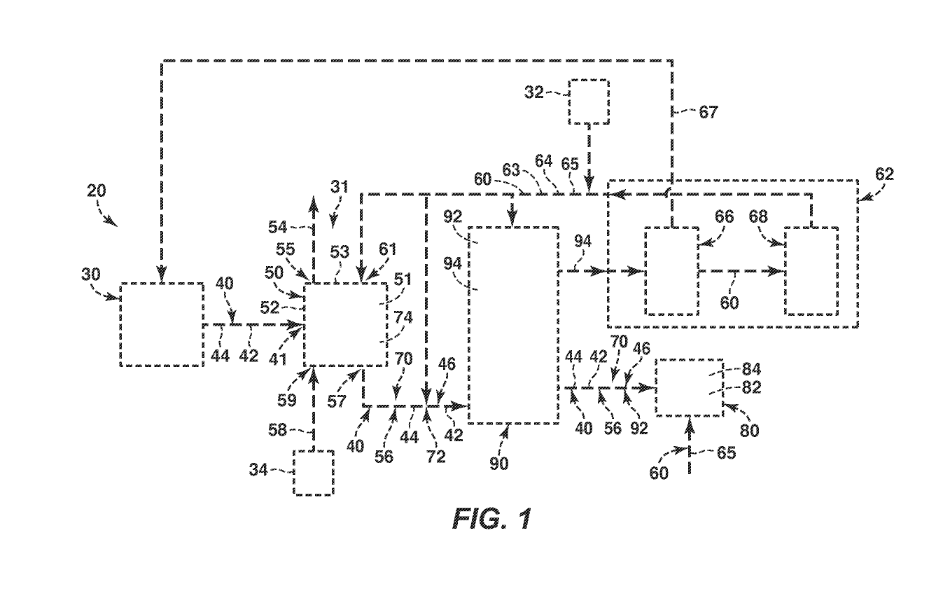

FIG. 1 is a schematic representation of illustrative, non-exclusive examples of mining operations 20 that may include and/or utilize the systems and/or methods according to the present disclosure. FIG. 1 illustrates several options, variations, and/or embodiments of mining operation 20, and it is within the scope of the present disclosure that a particular mining operation 20 may include, or may not include, any of the structures, streams, and/or materials that are illustrated in FIG. 1. It is further within the scope of the present disclosure that a particular mining operation also may include one or more other structures, streams, and/or materials.

In some embodiments, mining operation 20 may include and/or be in material communication with (i.e., may be configured to provide, receive, and/or exchange one or more material streams with) a mine tailings generation site 30, which in turn is in material communication with a mine tailings dewatering system, or facility, 31. The mine tailings generation site may be configured to generate a mine tailings slurry 40 that includes mine tailings 42 and water 44, and this slurry may be pumped, flowed, or otherwise transported or delivered to mine tailings dewatering system 31 to remove at least a portion of the water therefrom.

Mine tailings dewatering system 31 may include at least one mixing vessel 50 that is configured to add one or more additives to the mine tailings slurry, such as to assist in or otherwise promote the dewatering process. For example, mine tailings slurry 40 may be supplied to a mixing vessel 50, which may include and/or be a thickening assembly 52. The mixing vessel also may receive a flocculant 58. Flocculant 58, when utilized, may be referred to herein as, and/or may be, a flocculant stream 58, and may be received by the mixing vessel from a flocculant supply system 34. The mixing vessel further may receive a water-absorbing polymer 60 and/or an encapsulated water-absorbing polymer 65 from a water-absorbing polymer supply system 32. Water-absorbing polymer 60 also may be referred to herein as, and/or may be, a water-absorbing polymer stream 60. Encapsulated water-absorbing polymer 65 includes water-absorbing polymer 60 that is encapsulated in a coating material 64. Accordingly, encapsulated water-absorbing polymer 65 also may be referred to herein as, and/or may be, an encapsulated water-absorbing polymer stream 65.

When utilized in a particular mine tailings dewatering system 31 that further utilizes both flocculant 58 and water-absorbing polymer 60 (and/or an encapsulated water-absorbing polymer 65), the mixing vessel may combine the mine tailings slurry, the flocculant, and the water-absorbing polymer within an internal volume 51 thereof. The mixing vessel then may generate, or produce, an underflow 56, which also may be referred to herein as, and/or may be, an underflow stream 56, a high solids content stream 56, and/or an augmented mine tailings slurry 46. The mixing vessel also may generate, or produce, an overflow 54, which also may be referred to herein as, and/or may be, an overflow stream 54 and/or a low solids content stream 54. Overflow 54 may be separate from, may be spaced apart from, and/or may include a different composition than underflow 56. As an illustrative, non-exclusive example, underflow 56 may include a greater solids content than a solids content of overflow 54. As another illustrative, non-exclusive example, overflow 54 may include a greater liquid content than a liquid content of underflow 56.

Underflow 56 may be conveyed, pumped, and/or piped, such as through a pipe 70, to a mine tailings dewatering site 80, where it may form a mine tailings deposit 82. In such an embodiment, and as discussed herein, water-absorbing polymer 60 (and/or encapsulated water-absorbing polymer 65) may be selected such that it may initiate absorption of water from underflow 56, thereby decreasing a water content of mine tailings 42 that are contained therein (or at least partially dewatering the mine tailings slurry), subsequent to formation of mine tailings deposit 82 within mine tailings dewatering site 80.

Alternatively, and prior to being conveyed to the mine tailings dewatering site, the underflow optionally may be provided to a separation assembly 90. Water-absorbing polymer 60 may absorb water from underflow 56 within and/or prior to delivery to separation assembly 90 to produce dewatered mine tailings slurry 92 and swollen water-absorbing polymer 94. Separation assembly 90 may remove or otherwise separate dewatered mine tailings slurry 92 from swollen water-absorbing polymer 94. Dewatered mine tailings slurry 92 optionally may be provided to mine tailings dewatering site 80, such as by being trucked, pumped, piped, and/or otherwise conveyed to the mine tailings dewatering site, and may form mine tailings deposit 82 therein.

In addition, and while not required in all embodiments, swollen water-absorbing polymer 94 that is separated from the underflow may be provided to water-absorbing polymer recycle system 62. The water-absorbing polymer recycle system may include a polymer drying assembly 66, which may be configured to remove water from, release water from, and/or dewater, the swollen water-absorbing polymer and to produce water-absorbing polymer 60, which also may be referred to herein as regenerated water-absorbing polymer 60. Water-absorbing polymer 60 then may be provided to a polymer coating assembly 68, which may coat, encapsulate, and/or otherwise cover water-absorbing polymer 60 with coating material 64 to produce encapsulated water-absorbing polymer 65. As illustrated, water-absorbing polymer 60 (which may be included in encapsulated water-absorbing polymer 65, when present) then may be discharged from water-absorbing polymer recycle system 62 and provided, or recycled, to another component of mining operation 20, such as to water-absorbing polymer supply system 32 and/or to mixing vessel 50.

Drying assembly 66 also may produce released water 67, which may be referred to herein as released water stream 67. Released water 67 may be discharged from the drying assembly separately from water-absorbing polymer 60 and optionally may be recycled to another component of mining operation 20, such as to mine tailings generation site 30.

Additionally or alternatively, and in other embodiments, mining operation 20 may not include mixing vessel 50, water-absorbing polymer 60 may not be provided to internal volume 51 of mixing vessel 50, and/or it may be desirable to combine an additional volume of water-absorbing polymer 60 with underflow 56 and/or with augmented mine tailings slurry 46. Under these conditions, mine tailings slurry 40, underflow 56 that may or may not include water-absorbing polymer 60 but includes mine tailings 42 and water 44, and/or augmented mine tailings slurry 46 may be conveyed via pipe 70 to mine tailings dewatering site 80. Pipe 70 may include an injection port 72 that may be configured to receive water-absorbing polymer 60 such that water-absorbing polymer 60 mixes with mine tailings slurry 40 within pipe 70 to produce augmented mine tailings slurry 46 (or to combine additional water-absorbing polymer 60 with augmented mine tailings slurry 46).

Augmented mine tailings slurry 46 then may be provided to mine tailings dewatering site 80. Subsequent to augmented mine tailings slurry 46 being provided to mine tailings dewatering site 80, water-absorbing polymer 60 may absorb water 44 from the augmented mine tailings slurry, thereby decreasing a water content of mine tailings 42 that are contained therein (or at least partially dewatering mine tailings slurry 40).

Additionally or alternatively, the augmented mine tailings slurry also may optionally be provided to separation assembly 90 prior to being provided to mine tailings dewatering site 80. Separation assembly 90 may separate the augmented mine tailings slurry into dewatered mine tailings slurry 92 and swollen water-absorbing polymer 94, with dewatered mine tailings slurry 92 subsequently being provided to mine tailings dewatering site 80, as discussed herein. In addition, and as also discussed, swollen water-absorbing polymer 94 optionally may be provided to polymer drying assembly 66 and/or polymer coating assembly 68 of water-absorbing polymer recycle system 62 to produce water-absorbing polymer 60 and/or encapsulated water-absorbing polymer 65, which then may be provided to another component of mining operation 20, such as to injection port 72.

In other embodiments, mine tailings slurry 40 and water-absorbing polymer 60 (and/or encapsulated water-absorbing polymer 65) may be provided directly to separation assembly 90. As discussed, the water-absorbing polymer may absorb water from the mine tailings slurry within the separation assembly to produce dewatered mine tailings slurry 92 and swollen water-absorbing polymer 94, which may be separately discharged from the separation assembly after removal, or separation, of the swollen water-absorbing polymer from the dewatered mine tailings slurry 92. Subsequently, dewatered mine tailings slurry 92 may be provided to mine tailings dewatering site 80. Furthermore, swollen water-absorbing polymer 94 optionally may be provided to polymer drying assembly 66 and/or polymer coating assembly 68 of water-absorbing polymer recycle system 62 to produce water-absorbing polymer 60 and/or encapsulated water-absorbing polymer 65, which then may be provided to another component of mining operation 20, such as to separation assembly 90.

Additionally or alternatively, and in other embodiments, mine tailings slurry 40 and water-absorbing polymer 60 (and/or encapsulated water-absorbing polymer 65) may be provided directly to mine tailings dewatering site 80. As an illustrative, non-exclusive example, and as discussed herein with reference to methods 200, mine tailings 42 within mine tailings slurry 40 and water-absorbing polymer 60 both may be distributed and/or otherwise located within mine tailings dewatering site 80. Subsequently, one or more mechanical incorporation devices 84 may be utilized to mechanically incorporate, or mix, water-absorbing polymer 60 into mine tailings 42. The water-absorbing polymer then may absorb water 44 from the mine tailings slurry, thereby decreasing a water content thereof. Illustrative, non-exclusive examples of mechanical incorporation devices 84 include any suitable tractor, all-terrain vehicle, injector, rototiller, disk, and/or plow.

As discussed, it is within the scope of the present disclosure that mining operation 20 and/or mine tailings dewatering system 31 may include any suitable combination of the structures and/or may utilize any combination of the methods that are disclosed herein. Additionally or alternatively, it also within the scope of the present disclosure that mining operation 20 further may include additional structures and/or may utilize additional methods that may be known to conventional mining operations 20 but that are not discussed in detail herein, and mine tailings dewatering system 31 further may include additional structures and/or may utilize additional methods that may be known to conventional mine tailings dewatering systems but that are not discussed in detail herein. Similarly, the structures, streams, and/or materials disclosed herein may take, include, and/or define any suitable form and/or function, illustrative, non-exclusive examples of which are discussed herein.

With this in mind, mine tailings generation site 30 may include any suitable mine and/or mining operation that may produce mine tailings slurry 40. As illustrative, non-exclusive examples, this may include any suitable oil sands mine and/or tar sands mine. In addition, mine tailings generation site 30 may generate, or produce, mine tailings slurry 40 in any suitable manner. As an illustrative, non-exclusive example, mine tailings generation site 30 may include a mining operation that may utilize hot water extraction technology to liberate bitumen from finely crushed bitumen-containing ore. This may include combining, or mixing, the bitumen-containing ore with hot water and/or one or more dispersion agents to separate the bitumen from a remainder of the bitumen-containing ore.

Mine tailings slurry 40 may include and/or be any suitable slurry that may be generated by mine tailings generation site 30 and that includes mine tailings 42 and water 44. As an illustrative, non-exclusive example, the above-described bitumen separation process may produce a bitumen-containing, or bitumen-rich, stream (i.e., a product stream) and a waste stream. The waste stream may contain a large number of small particles (i.e., particles with a size of less than a few micrometers, such as clays) suspended in water. Typically, the waste stream may include 30-60 wt % water, and it may be desirable to remove at least a portion of this water from the mine tailings slurry, such as by using the systems and/or methods disclosed herein. It is within the scope of the present disclosure that mine tailings slurry 40 may include, and/or be, the above-described waste stream. However, it is also within the scope of the present disclosure that the waste stream may receive further processing prior to being utilized within mining operation 20 as mine tailings slurry 40. Thus, mine tailings slurry 40 also may include and/or be any suitable oil sands tailings, thickened tailings (TT), mature fine tailings (MFT), solvent recovery unit tailings (TSRU), flotation tailings (FT), and/or fluid fine tailings (FFT).

As discussed, mine tailings slurry 40 may include, and/or be, a waste stream from a bitumen recovery process. As such, it is within the scope of the present disclosure that the mine tailings slurry further may include bitumen. As illustrative, non-exclusive examples, mine tailings slurry 40 may include at least 0.005 wt % bitumen, at least 0.01 wt % bitumen, at least 0.05 wt % bitumen, at least 0.1 wt % bitumen, at least 0.5 wt %, at least 1 wt %, at least 2 wt %, at least 3 wt %, at least 4 wt %, at least 5 wt %, or at least 6 wt % bitumen. As additional illustrative, non-exclusive examples, the mine tailings slurry may include less than 15 wt %, less than 14 wt %, less than 13 wt %, less than 12 wt %, less than 11 wt %, less than 10 wt %, less than 9 wt %, less than 8 wt %, less than 7 wt %, less than 6 wt %, less than 5 wt % bitumen, less than 4 wt % bitumen, less than 3 wt % bitumen, less than 2 wt % bitumen, less than 1 wt % bitumen, or less than 0.5 wt % bitumen.

Mine tailings slurry 40 may include small particles (i.e., particles with a size, or diameter, of less than 44 micrometers), and it is within the scope of the present disclosure that the mine tailings slurry also may include larger particles (i.e., particles with a size, or diameter, of greater than 44 micrometers, such as sand). When mine tailings slurry 40 includes both small particles and sand, a sand-to-fines ratio of the mine tailings slurry may define any suitable value. As illustrative, non-exclusive examples, the sand-to-fines ratio may be less than 4:1, less than 3:1, less than 2:1, less than 1:1, less than 1:1.2, less than 1:2, less than 1:3, less than 1:4, less than 1:5: or less than 1:6. Additionally or alternatively, the sand-to-fines ratio also may be at least 1:15, at least 1:14, at least 1:13, at least 1:12, at least 1:11, at least 1:10, at least 1:9, at least 1:8, at least 1:7, at least 1:6, at least 1:5, at least 1:4, at least 1:3, at least 1:2, at least 1:1.1, or at least 1:1.

Water-absorbing polymer 60 may include any suitable material that may define any suitable form. In addition, water-absorbing polymer 60 may be present within underflow 56 (or augmented mine tailings slurry 46), separation assembly 90, mine tailings disposal site 80, and/or mine tailings deposit 82 in any suitable concentration. As illustrative, non-exclusive examples, a concentration (in weight percent of solids or weight percent on a dry mass basis) of water-absorbing polymer 60 relative to mine tailings 42 may be at least 0.00001 wt %, at least 0.00005 wt %, at least 0.0001 wt %, at least 0.0005 wt %, at least 0.001 wt %, at least 0.005 wt %, at least 0.01 wt %, at least 0.05 wt %, at least 0.1 wt %, at least 0.5 wt %, or at least 1 wt %. Additionally or alternatively, the concentration of the water-absorbing polymer may be less than 5 wt %, less than 4.5 wt %, less than 4 wt %, less than 3.5 wt %, less than 3 wt %, less than 2.5 wt %, less than 2 wt %, less than 1.5 wt %, less than 1 wt %, less than 0.5 wt %, less than 0.1 wt %, less than 0.05 wt %, or less than 0.01 wt %.

As another illustrative, non-exclusive example, a material that comprises water-absorbing polymer 60 may be selected such that the water-absorbing polymer will absorb at least a threshold mass of water per gram (or gram on a dry weight basis) of the water-absorbing polymer. This may include absorbing at least 1 gram (g), at least 5 g, at least 10 g, at least 50 g, at least 100 g, at least 200 g, at least 300 g, at least 400 g, at least 500 g, at least 1,000 g, or at least 5,000 g of water per gram of water-absorbing polymer. Additionally or alternatively, this may include absorbing less than 20,000 g, less than 15,000 g, less than 10,000 g, less than 7,500 g, less than 5,000 g, less than 2,500 g, less than 1,000 g, less than 750 g, less than 500 g, or less than 400 g of water per gram of water-absorbing polymer.

Illustrative, non-exclusive examples of water-absorbing polymers 60 that may be utilized with and/or included in the systems and methods according to the present disclosure include any suitable crosslinked polymer, polyactylate, polyacrylamide, acrylic-acrylamide copolymer, hydrolyzed cellulose-polyacrylonitrile, starch-polyacrylonitrile graft copolymer, maleic anhydride copolymer, ethylenically derived monomomer, ethylenically unsaturated monomer, acrylate, anionic polyacrylamide, sodium polyacrylate, polyacrylamide copolymer, ethylene maleic anhydride copolymer, carboxymethylcellulose, polyvinyl alcohol copolymer, polyethylene oxide, synthetic hydrophilic polymer, naturally occurring hydrophilic polymer, water insoluble polymer, silica gel, and/or aerogel. Additional illustrative, non-exclusive examples of water-absorbing polymer 60 include any suitable non-crosslinked polymer, powdered desiccant, biodegradable material, and/or non-biodegradable material.

Water-absorbing polymer 60 may comprise a plurality of water-absorbing polymer particles, such as a powder, a dry powder, and/or a granular material, that may define a polymer particle size distribution. This may include any suitable single mode, bimodal, and/or multimodal particle size distribution. In addition, the plurality of water-absorbing polymer particles may define any suitable average, mean, and/or median characteristic dimension, such as a size, diameter, and/or effective diameter. As illustrative, non-exclusive examples, the characteristic dimension may be at least 1 micrometer (um), at least 5 um, at least 10 um, at least 50 um, at least 100 um, at least 500 um, at least 1,000 um, or at least 5,000 um. Additionally or alternatively, the characteristic dimension also may be less than 20,000 um, less than 15,000 um, less than 10,000 um, less than 7,500 um, less than 5,000 um, less than 2,500 um, or less than 1,000 um.

It is within the scope of the present disclosure that encapsulated water-absorbing polymer 65, when utilized, may include any of the water-absorbing polymers 60 that are described herein (beneath/within coating material 64). It is also within the scope of the present disclosure that water-absorbing polymer 60 and/or encapsulated water-absorbing polymer 65 may be pure, may not be diluted, and/or may not include carrier and/or filler materials prior to being combined with mine tailings slurry 40. As an illustrative, non-exclusive example, and when the water-absorbing polymer includes a plurality of water-absorbing polymer particles, the plurality of water-absorbing polymer particles may be conveyed in dry, powdered, and/or granular form and/or may be dry immediately prior to being mixed with mine tailings slurry 40.

However, it is also within the scope of the present disclosure that water-absorbing polymer 60 may include a fluid carrier 63 and that the water-absorbing polymer may be suspended or otherwise entrained or mixed within the fluid carrier prior to being combined with mine tailings slurry 40. Illustrative, non-exclusive examples of fluid carriers that may be utilized with the systems and methods according to the present disclosure include fluid carriers that are not absorbed by water-absorbing polymer 60, fluid carriers within which the water-absorbing polymer is not soluble or otherwise reactive or negatively altered, and/or fluid carriers that do not degrade coating material 64 of encapsulated water-absorbing polymer 65. More specific but still illustrative, non-exclusive examples of fluid carriers that may be utilized with the systems and methods according to the present disclosure include any suitable non-aqueous fluid, non-aqueous liquid, hydrocarbon fluid, hydrocarbon liquid, alcohol, and/or alkane.

Mixing vessel 50 and/or thickening assembly 52 may include a tank body 53 that defines internal volume 51. The tank body further may define a flocculant inlet 59 to receive flocculant 58 into internal volume 51, a water-absorbing polymer inlet 61 to receive water-absorbing polymer 60 into internal volume 51, and a mine tailings inlet 41 to receive mine tailings slurry 40 into internal volume 51. The tank body also may define an overflow outlet 55 to produce overflow 54, or overflow stream 54, from internal volume 51 and an underflow outlet 57 to produce underflow 56, or underflow stream 56, from internal volume 51. In addition, mixing vessel 50 also may include, or define, a mixing structure 74 that is configured to combine mine tailings slurry 40, flocculant 58, and water-absorbing polymer 60 within internal volume 51. Subsequently, these materials may be allowed to flocculate within internal volume 51 for at least a threshold thickening time, illustrative, non-exclusive examples of which are disclosed herein, thereby producing overflow 54 and underflow 56.

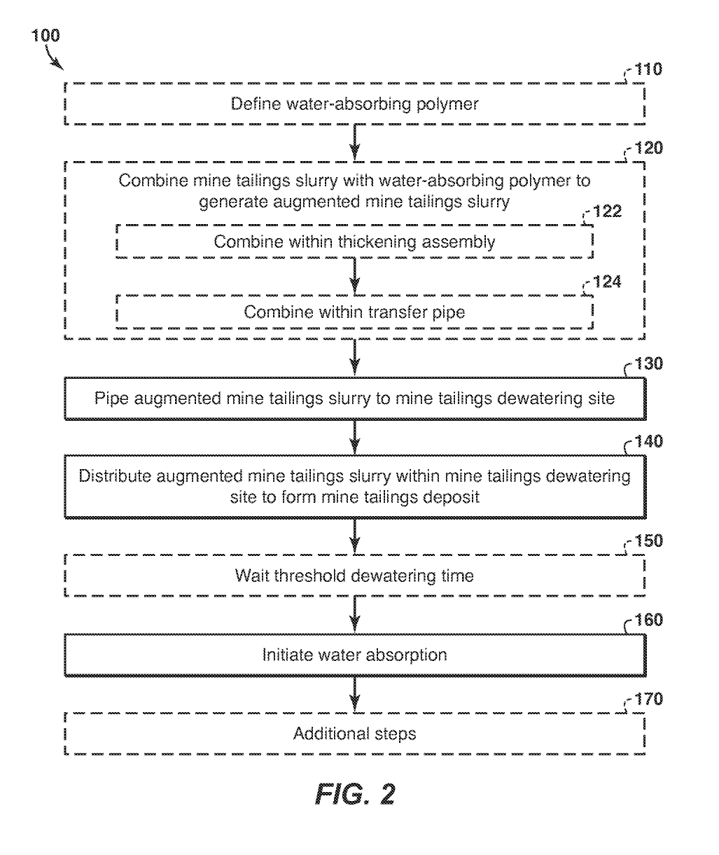

FIG. 2 is a flowchart depicting methods 100 according to the present disclosure of dewatering mine tailings. Methods 100 may include defining a water-absorbing polymer at 110 and include combining a mine tailings slurry with the water-absorbing polymer to generate an augmented mine tailings slurry at 120. Methods 100 further include piping the augmented mine tailings slurry through a transfer pipe to a mine tailings dewatering site at 130 and distributing the augmented mine tailings slurry within the mine tailings dewatering site to form a mine tailings deposit at 140. Methods 100 further may include waiting at least a threshold dewatering time at 150, initiating water absorption by the water-absorbing polymer at 160, and performing one or more additional method steps at 170.

Defining the water-absorbing polymer at 110 may include selecting, regulating, creating, synthesizing, and/or formulating the water-absorbing polymer, or any component and/or property thereof, based upon any suitable criteria. As an illustrative, non-exclusive example, the defining at 110 may include forming, or selecting, an encapsulated water-absorbing polymer that is encapsulated by a coating material. This may, but is not required to, include forming the encapsulated water-absorbing polymer using methods 300 that are discussed in more detail herein.

As another illustrative, non-exclusive example, and when the defining at 110 includes forming the encapsulated water-absorbing polymer, the defining at 110 further may include selecting at least one property of the coating material. The selecting may be based, at least in part, upon any suitable criteria, illustrative, non-exclusive examples of which include a threshold thickening time for the augmented mine tailings slurry, a threshold piping time for the augmented mine tailings slurry, a threshold distributing time for the augmented mine tailings slurry, and/or the threshold dewatering time. Illustrative, non-exclusive examples of these times are discussed in more detail herein. Illustrative, non-exclusive examples of properties of the coating material include a composition of the coating material, a thickness of the coating material, and/or the threshold isolation time that may be provided by the coating material.

It is within the scope of the present disclosure that the coating material may include and/or be any suitable coating material and/or may include and/or be defined by any suitable composition, or chemical composition. As an illustrative, non-exclusive example, the coating material may include and/or be a water-soluble coating material. As another illustrative, non-exclusive example, the coating material may include and/or be a starch.

As discussed, the water-absorbing polymer and/or the encapsulated water-absorbing polymer may be selected such that water absorption by the water-absorbing polymer is initiated subsequent to deposition of the augmented mine tailings slurry within the mine tailings dewatering site, subsequent to piping the augmented mine tailings slurry to the mine tailings dewatering site, and/or subsequent to formation of the mine tailings deposit within the mine tailings dewatering site. As such, it is within the scope of the present disclosure that, when the water-absorbing polymer is encapsulated by the coating material, the coating material may be selected to fluidly isolate the water-absorbing polymer from water within the augmented mine tailings slurry for at least the threshold isolation time.

Illustrative, non-exclusive examples of threshold isolation times according to the present disclosure include threshold isolation times of at least 0.5 hours, at least 0.75 hours, at least 1 hour, at least 2 hours, at least 3 hours, at least 4 hours, at least 5 hours, at least 6 hours, at least 8 hours, at least 10 hours, at least 12 hours, at least 14 hours, at least 16 hours, at least 18 hours, at least 20 hours, or at least 22 hours. Additionally or alternatively, the threshold isolation time also may be less than 48 hours, less than 44 hours, less than 40 hours, less than 36 hours, less than 32 hours, less than 28 hours, less than 24 hours, less than 22 hours, less than 20 hours, less than 18 hours, less than 16 hours, less than 14 hours, less than 12 hours, or less than 10 hours.

As yet another illustrative, non-exclusive example, the mine tailings slurry may include a plurality of tailings particles, such as a plurality of clay particles, that may define a plurality of tailings particle sizes. In addition, the water-absorbing polymer may define a plurality of water-absorbing polymer particles that define a plurality of pores. Under these conditions, the defining at 110 also may include selecting a crosslinking density of the water-absorbing polymer such that the water-absorbing polymer defines a pore size, or an average pore size, that is greater than at least a portion of the plurality of tailings particle sizes. This may permit a portion of the tailings particles to become entrained, entrapped, and/or otherwise enclosed within the plurality of pores, thereby changing an overall density of the water-absorbing polymer particles. As an illustrative, non-exclusive example, the entrained tailings particles may increase, or otherwise adjust, the overall density of the water-absorbing polymer particles such that it is closer to the density of the tailings particles than a comparable polymer particle that does not include the entrained tailings particles. Adjusting the density of the water-absorbing polymer particles may permit, or provide, an improved distribution of the water-absorbing polymer (and/or encapsulated water-absorbing polymer) within the mine tailings slurry. Although not required, this in turn may improve the water-absorbing polymer's effectiveness to dewater the slurry and/or reduce the time required to remove sufficient amounts of water from the slurry.

As another illustrative, non-exclusive example, a water absorption rate of the water-absorbing polymer may be controlled, selected, and/or based upon a particle size of the water-absorbing polymer particles that may be defined by the water-absorbing polymer, with smaller water-absorbing polymer particles absorbing water more quickly (or having a higher water absorption rate) than larger particles. Additionally or alternatively, the water absorption rate also may be controlled, selected, and/or based upon a crosslinking density of the water-absorbing polymer, with lower crosslinking densities absorbing water more quickly (or having a higher water absorption rate) than higher crosslinking densities. Thus, the defining at 110 also may include selecting an average polymer particle size and/or an average crosslinking density based, at least in part, on a desired water absorption rate by the water-absorbing polymer particles.

Additionally or alternatively, a particle size distribution of the water-absorbing polymer particles may be selected such that a portion of the water-absorbing polymer particles absorb water at a water absorption rate that is different from a remainder of the water-absorbing polymer particles. Thus, the defining at 110 also may include selecting a bimodal, or multimodal, particle size distribution that includes a plurality of subsets of water-absorbing polymer particles that absorb water at different water absorption rates (or different average water absorption rates).

As yet another illustrative, non-exclusive example, some water-absorbing polymers may crosslink, form a network, and/or form one or more fluid conduits within the augmented mine tailings slurry and/or the mine tailings deposit. With this in mind, the defining at 110 also may include selecting the water-absorbing polymer, or any suitable property thereof, such that the water-absorbing polymer increases the fluid permeability of the augmented mine tailings slurry and/or of the mine tailings deposit by at least a threshold fluid permeability increase. As illustrative, non-exclusive examples, the fluid permeability increase may be at least 2 times, at least 3 times, at least 4 times, at least 5 times, at least 6 times, at least 7 times, at least 8 times, at least 9 times, or at least 10 times the fluid permeability of a comparable mine tailings deposit that does not include the water-absorbing polymer.

As another illustrative, non-exclusive example, the defining at 110 additionally or alternatively may include selecting and/or adjusting a concentration of the water-absorbing polymer within the augmented mine tailings slurry (or within the mine tailings that are present therein) based upon one or more properties of the mine tailings slurry and/or based upon one or more properties of the augmented mine tailings slurry. As illustrative, non-exclusive examples, the concentration may be selected and/or adjusted based, at least in part, on a property of the mine tailings slurry prior to combination with the mass of water-absorbing polymer, a property the mine tailings slurry subsequent to combination with the mass of water-absorbing polymer, the weather, an ambient temperature, a particle size distribution within the mine tailings slurry, a clay content of the mine tailings slurry, a type of clay within the mine tailings slurry, a turbidity of the mine tailings slurry, and/or a desired shear strength of the mine tailings deposit that may be formed from the augmented mine tailings slurry.

Combining the mine tailings slurry with the water-absorbing polymer to generate the augmented mine tailings slurry at 120 may include combining and/or otherwise mixing the mine tailings slurry and the water-absorbing polymer in any suitable manner and/or using any suitable structure. This may include actively and/or passively mixing the mine tailings slurry and the water-absorbing polymer, injecting the mine tailings slurry into the water-absorbing polymer, and/or injecting the water-absorbing polymer into the mine tailings slurry. As discussed, the mine tailings slurry may include mine tailings and water. As also discussed, the water-absorbing polymer may include, be, and/or form a portion of an encapsulated water-absorbing polymer.

As an illustrative, non-exclusive example, the combining at 120 may include combining within a thickening assembly at 122. Illustrative, non-exclusive examples of thickening assemblies are discussed herein. When the combining at 120 includes combining within the thickening assembly, methods 100 further may include combining both the mine tailings slurry and the water-absorbing polymer with a flocculant within the thickening assembly to generate the augmented mine tailings slurry.

It is within the scope of the present disclosure that methods 100 further may include retaining the augmented mine tailings slurry within the thickening assembly for at least a threshold thickening time subsequent to the combining at 122 and prior to the piping at 130. Illustrative, non-exclusive examples of threshold thickening times according to the present disclosure include threshold thickening times of at least 15 minutes, at least 30 minutes, at least 45 minutes, at least 1 hour, at least 1.5 hours, at least 2 hours, at least 2.5 hours, at least 3 hours, at least 3.5 hours, or at least 4 hours.

During the threshold thickening time, the flocculant may cause at least a portion of the tailings particles within the mine tailings slurry to flocculate. Subsequently, at least a portion of the flocculated mine tailings, together with a portion of the water and at least a portion of the water-absorbing polymer may be produced from the thickening assembly as an underflow, which also may be referred to herein as an underflow stream and/or as the augmented mine tailings slurry. In addition, the thickening assembly also may produce an overflow, which also may be referred to herein as an overflow stream, and a solids content of the underflow may be greater than a solids content of the overflow.

When the combining at 120 includes combining within the thickening assembly at 122, it is within the scope of the present disclosure that the thickening assembly may be located at least a threshold piping distance from the mine tailings dewatering site and that the piping at 130 may include piping the augmented mine tailings slurry through the transfer pipe and over and/or across at least the threshold piping distance. Illustrative, non-exclusive examples of threshold piping distances according to the present disclosure include threshold piping distances of at least 100 meters (m), at least 200 m, at least 400 m, at least 600 m, at least 800 m, at least 1,000 m, at least 1,250 m, at least 1,500 m, at least 1,750 m, at least 2,000 m, at least 2,500 m, at least 3,000 m, at least 3,500 m, at least 4,000 m, at least 4,500 m, at least 5,000 m, at least 5,500 m, or at least 6,000 m. Additional illustrative, non-exclusive examples of threshold piping distances include distances that are less than 2,500 m, less than 2,000 m, less than 1,500 m, less than 1,000 m, or less than 500 m.

As another illustrative, non-exclusive example, the combining at 120 also may include combining within the transfer pipe, as indicated at 124. As an illustrative, non-exclusive example, and as discussed, the transfer pipe may include an injection port, and the combining at 124 may include injecting the water-absorbing polymer into the injection port. When methods 100 include the combining at 124, it is within the scope of the present disclosure that the injection port may be located less than a threshold injection port distance from the mine tailings dewatering site and that the piping at 130 may include piping the augmented mine tailings slurry over and/or across the threshold injection port distance. Illustrative, non-exclusive examples of threshold injection port distances according to the present disclosure include threshold injection port distances of less than 200 meters, less than 150 meters, less than 125 meters, less than 100 meters, less than 90 meters, less than 80 meters, less than 70 meters, less than 60 meters, less than 50 meters, less than 40 meters, less than 30 meters, less than 20 meters, less than 15 meters, less than 10 meters, less than 5 meters, or less than 2.5 meters.

Additionally or alternatively, it is also within the scope of the present disclosure that the injection port may be associated with, near, and/or integrated into a pump that is configured to provide a motive force for the piping at 130. Under these conditions, the threshold injection port distance may be less than 3,000 m, less than 2,750 m, less than 2,500 m, less than 2,250 m, less than 2,000 m, less than 1,750 m, less than 1,500 m, less than 1,250 m, or less than 1,000 m. Additionally or alternatively, the threshold injection port distance also may be greater than 500 m, greater than 1,000 m, greater than 1,500 m greater than 2,000 m, or greater than 2,500 m.

Piping the augmented mine tailings slurry to the mine tailings dewatering site at 130 may include piping the augmented mine tailings slurry through the transfer pipe. This may include pumping, transporting, and/or otherwise conveying the augmented mine tailings slurry over any suitable piping distance, illustrative, non-exclusive examples of which are disclosed herein. Additionally or alternatively, the piping at 130 also may include piping for at least a threshold piping time. Illustrative, non-exclusive examples of threshold piping times according to the present disclosure include threshold piping times of at least 5 minutes, at least 10 minutes, at least 15 minutes, at least 20 minutes, at least 25 minutes, at least 30 minutes, at least 35 minutes, at least 40 minutes, at least 45 minutes, at least 50 minutes, or at least 55 minutes. Additional illustrative, non-exclusive examples of threshold piping times according to the present disclosure include threshold piping times of less than 120 minutes, less than 110 minutes, less than 100 minutes, less than 90 minutes, less than 80 minutes, less than 70 minutes, or less than 60 minutes.

Distributing the augmented mine tailings slurry within the mine tailings dewatering site to form the mine tailings deposit at 140 may include distributing the augmented mine tailings slurry in any suitable manner. As illustrative, non-exclusive examples, the distributing at 140 may include flowing the augmented mine tailings slurry within the mine tailings dewatering site, flowing the augmented mine tailings slurry down a sloped surface that is present within and/or defines the mine tailings dewatering site, spraying the augmented mine tailings slurry into the mine tailings dewatering site, and/or broadcasting the augmented mine tailings slurry into the mine tailings dewatering site.

When the distributing at 140 includes flowing the augmented mine tailings slurry down the sloped surface, the sloped surface may define a surface grade of at least 0.25%, at least 0.5%, at least 0.75%, at least 1%, at least 1.5%, at least 2%, at least 2.5%, or at least 3%. Additionally or alternatively, the sloped surface also may define a surface grade of less than 7%, less than 6.5%, less than 6%, less than 5.5%, less than 5%, less than 4.5%, less than 4%, less than 3.5%, or less than 3%.

It is within the scope of the present disclosure that the distributing at 140 may include distributing a given volume of mine tailings for at least a threshold distributing time and/or that, subsequent to the piping at 130, the given volume of the augmented mine tailings slurry may move, settle, flow, and/or expand within the mine tailings dewatering site for at least the threshold distributing time. Illustrative, non-exclusive examples of threshold distributing times according to the present disclosure include threshold distributing times of at least 0.5 hours, at least 0.75 hours, at least 1 hour, at least 1.25 hours, at least 1.5 hours, at least 1.75 hours, at least 2 hours, at least 2.25 hours, at least 2.5 hours, at least 2.75 hours, at least 3 hours, at least 3.25 hours, or at least 3.5 hours. Additional illustrative, non-exclusive examples of threshold distributing times according to the present disclosure include threshold distributing times of less than 8 hours, less than 7 hours, less than 6 hours, less than 5 hours, less than 4.75 hours, less than 4.5 hours, less than 4.25 hours, or less than 4 hours.

Optionally waiting at least the threshold dewatering time at 150 may include waiting at least the threshold dewatering time subsequent to the distributing at 140 and prior to the initiating at 160. As an illustrative, non-exclusive example, the waiting at 150 may permit water that may be present within the augmented mine tailings slurry, and which will naturally separate from a remainder of the augmented mine tailings slurry on a time scale that is comparable to, or less than, the threshold dewatering time, to separate and/or flow away from the remainder of the augmented mine tailings slurry prior to absorption of water by the water-absorbing polymer (such as during the initiating at 160). Thus, the waiting at 150 may permit a lower concentration, or mass, of water-absorbing polymer to dewater a given mass of the mine tailings slurry.

Illustrative, non-exclusive examples of threshold dewatering times according to the present disclosure include threshold dewatering times of at least 0.5 hours, at least 0.75 hours, at least 1 hour, at least 2 hours, at least 3 hours, at least 4 hours, at least 5 hours, at least 6 hours, at least 8 hours, at least 10 hours, at least 12 hours, at least 14 hours, at least 16 hours, at least 18 hours, at least 20 hours, or at least 22 hours. Additional illustrative, non-exclusive examples of threshold dewatering times according to the present disclosure include threshold dewatering times of less than 48 hours, less than 44 hours, less than 40 hours, less than 36 hours, less than 32 hours, less than 28 hours, less than 24 hours, less than 22 hours, less than 20 hours, less than 18 hours, less than 16 hours, less than 14 hours, less than 12 hours, or less than 10 hours.

Initiating water absorption by the water-absorbing polymer at 160 may include degrading the coating material to permit water absorption by the water-absorbing polymer. It is within the scope of the present disclosure that the degrading may be accomplished in any suitable fashion. As an illustrative, non-exclusive example, the degrading may include dissolving the coating material within the water that is present within the augmented mine tailings slurry. As another illustrative, non-exclusive example, the degrading may include oxidizing the coating material. As yet another illustrative, non-exclusive example, the degrading may be initiated responsive to fluid contact between the coating material and water. As another illustrative, non-exclusive example, the degrading may be initiated responsive to a decrease in a temperature of the coating material (such as when the augmented mine tailings slurry is produced during the combining at 120 at an elevated temperature and cools during the piping at 130, the distributing at 140, and/or the waiting at 160). Additionally or alternatively, it is also within the scope of the present disclosure that the degrading may not be responsive to, or at least may not be directly, or primarily, responsive to abrasion of the coating material (such as during the piping at 130 and/or during the distributing at 140).

Regardless of the specific mechanism that may be utilized to accomplish the initiating at 130, it is within the scope of the present disclosure that the initiating may be subsequent to the piping at 130, subsequent to the distributing at 140, and/or subsequent to the waiting at 150. As an illustrative, non-exclusive example, and as discussed, the combining at 120 may include combining the mine tailings slurry with the water-absorbing polymer prior to piping the augmented mine tailings slurry to the mine tailings dewatering site (at 130), distributing the augmented mine tailings slurry within the mine tailings dewatering site (at 140), and/or waiting the threshold dewatering time (at 150). As such, and should the water-absorbing polymer begin absorbing water from the augmented mine tailings slurry prior to the initiating at 150, a viscosity and/or shear strength of the augmented mine tailings slurry would increase, potentially dramatically. This would increase a resistance to flow and/or motion of the augmented mine tailings slurry, thereby increasing an expense of the piping at 130 and/or precluding the piping at 130 as a means of transferring the water-absorbing polymer. Thus, selection of the water-absorbing polymer and/or the coating material such that the water absorption by the water-absorbing polymer is initiated subsequent to the piping at 130, the distributing at 140, and/or the waiting at 150 may permit the piping at 130 and/or the distributing at 140, increasing an overall efficiency of methods 100 and/or enabling methods 100 to be performed.

Performing one or more additional method steps at 170 may include performing any suitable additional method steps prior to, during, and/or subsequent to performing a remainder of methods 100. As an illustrative, non-exclusive example, and subsequent to at least the distributing at 140, the performing at 170 may include incorporating an additional mass of water-absorbing polymer into the mine tailings deposit using methods 200, which are discussed herein. This may include incorporating an additional mass of water-absorbing polymer that is (compositionally) the same as, or at least similar to, the mass of water-absorbing polymer that was combined with the mine tailings slurry during the combining at 120 and/or incorporating an additional mass of water-absorbing polymer that is (compositionally) different from the mass of water-absorbing polymer that was combined with the mine tailings slurry during the combining at 120. As an illustrative, non-exclusive example, and since methods 200 do not include the piping at 130, the additional mass of water-absorbing polymer may not include the coating material and/or may begin to absorb water immediately upon contact therewith.

As another illustrative, non-exclusive example, and subsequent to the initiating at 160, the performing at 170 also may include reclaiming, reusing, and/or recycling the water-absorbing polymer using methods 400, which are discussed herein. Under these conditions, the mine tailings disposal site of methods 100 may include and/or be a temporary mine tailings storage site and/or may form a portion of and/or be associated with a separation assembly that may be utilized during methods 400.

As yet another illustrative, non-exclusive example, the performing at 170 also may include combining the mine tailings slurry (or the augmented mine tailings slurry) with an additional additive. Illustrative, non-exclusive examples of additional additives according to the present disclosure include a polymer flocculant, an anionic flocculant, a cationic flocculant, a divalent cationic flocculant, a trivalent cationic flocculant, a nonionic flocculant, a flocculant that includes magnesium, a flocculant that includes calcium, and/or another flocculant that may be utilized to further flocculate mine tailings from the mine tailings slurry. Additionally or alternatively, the additional additive also may include cement, a cementitious material, a fly compound, a coagulant, a desiccant, and/or Portland cement. Additionally or alternatively, the additional additive also may include another, or a second, water-absorbing polymer that is different from the water-absorbing polymer that is combined with the mine tailings slurry during the combining at 120. Additionally or alternatively, the additional additive also may include a material that is selected to increase a fluid permeability of the augmented mine tailings slurry and/or of the dewatered mine tailings slurry.

It is within the scope of the present disclosure that the mine tailings slurry may include and/or be a colloidal suspension and that changing the pH of the mine tailings slurry may decrease a stability of the colloidal suspension and/or generate separation of solids that may be present within the colloidal suspension from the water that is present within the colloidal suspension. Thus, an additional illustrative, non-exclusive example of an additional additive according to the present disclosure includes a pH modifier, such as an acid and/or a base.

As an illustrative, non-exclusive example, and when the pH modifier includes an acid, the performing at 170 may include decreasing the pH of the mine tailings slurry (or the augmented mine tailings slurry). This may include decreasing the pH to a pH that is less than 7.5, less than 7.4, less than 7.3, less than 7.2, less than 7.1, less than 7.0, less than 6.9, less than 6.8, less than 6.7, less than 6.6, less than 6.5, less than 6.4, less than 6.3, less than 6.2, less than 6.1, less than 6.0, less than 5.9, less than 5.8, less than 5.7, less than 5.6, or less than 5.5.

As another illustrative, non-exclusive example, and when the pH modifier includes a base, the performing at 170 also may include increasing the pH of the mine tailings slurry (or the augmented mine tailings slurry). This may include increasing the pH to a pH that is at least 8.5, at least 8.75, at least 9.0, at least 9.25, at least 9.5, at least 9.75, at least 10, at least 10.1, at least 10.2, at least 10.3, at least 10.4, at least 10.5, at least 10.6, at least 10.7, at least 10.8, at least 10.9, or at least 11.0.

It is within the scope of the present disclosure that the additional additive may be combined with the mine tailings slurry (or the augmented mine tailings slurry) at any suitable time and/or at any suitable point within methods 100. As an illustrative, non-exclusive example, the additional additive may be combined with the mine tailings slurry prior to the combining at 120. As another illustrative, non-exclusive example, the additional additive may be combined with the augmented mine tailings slurry subsequent to the combining at 120. As yet another illustrative, non-exclusive example, the additional additive may be combined with the mine tailings slurry during, or concurrently with, the combining at 120.

As another illustrative, non-exclusive example, and subsequent to the initiating at 160, the performing at 170 also may include crosslinking the water-absorbing polymer within the mine tailings slurry (or within the mine tailings deposit). It is within the scope of the present disclosure that the crosslinking may be responsive to the initiating at 160. Additionally or alternatively, it is also within the scope of the present disclosure that methods 100 further may include supplying an initiator to the mine tailings slurry and/or to the mine tailings deposit to initiate the crosslinking.

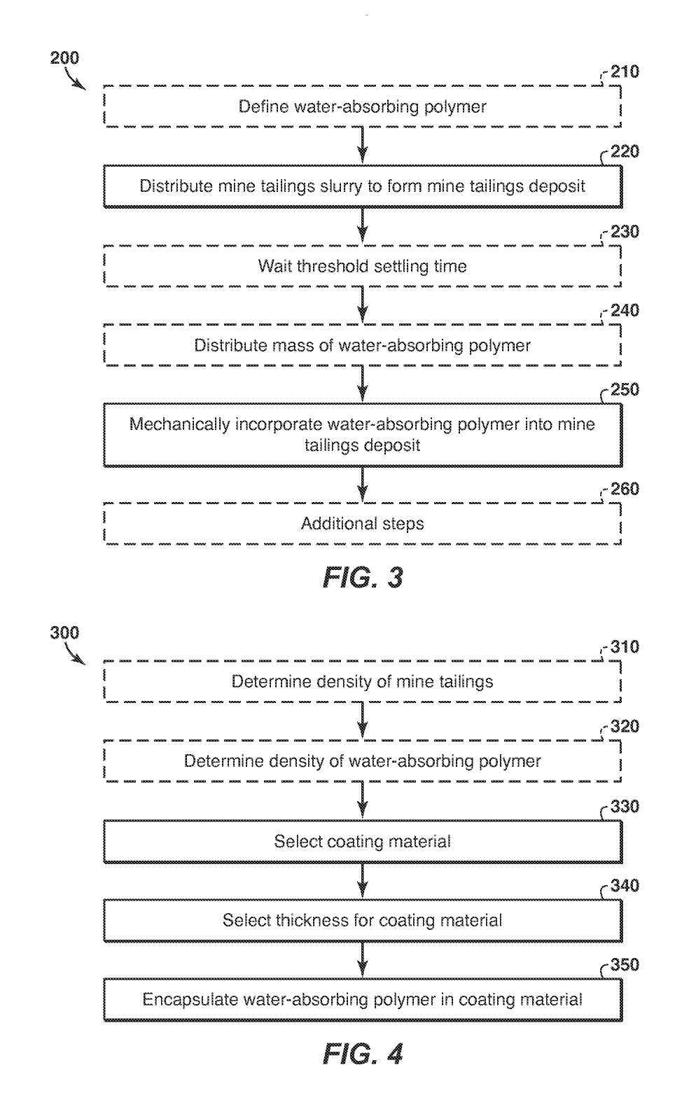

FIG. 3 is a flowchart depicting additional methods 200 according to the present disclosure of dewatering mine tailings. Methods 200 may include defining a water-absorbing polymer at 210 (which may be at least substantially similar to, or optionally even the same as, the defining at 110) and include distributing a mine tailings slurry, which includes mine tailings and water, within a mine tailings dewatering site to form a mine tailings deposit at 220. Methods 200 further may include waiting at least a threshold settling time at 230 and distributing a mass of water-absorbing polymer within the mine tailings dewatering site at 240. Methods 200 further include mechanically incorporating the mass of water-absorbing polymer into the mine tailings deposit at 250, and methods 200 may include performing one or more additional steps at 260.

Distributing the mine tailings slurry within the mine tailings dewatering site at 220 may include distributing the mine tailings slurry in any suitable manner. It is within the scope of the present disclosure that the distributing the mine tailings slurry at 220 may be similar to, at least substantially similar to, or even the same as, the distributing the augmented mine tailings slurry at 140, which is discussed in more detail herein with reference to methods 100.

Waiting at least the threshold settling time at 230 may include waiting any suitable settling time subsequent to the distributing at 220 and prior to the mechanically incorporating at 250. As an illustrative, non-exclusive example, and as discussed, the mechanically incorporating at 250 may include mechanically incorporating using one or more mechanical incorporation devices. The mechanical incorporation device may be configured to drive, or be driven or otherwise conveyed, across an upper surface of the mine tailings deposit. However, immediately subsequent to the distributing at 220, a shear strength of the mine tailings deposit may be insufficient to support the mechanical incorporation device and/or to permit the mechanical incorporation device to drive thereacross. As such, the waiting at 230 may permit the mechanically incorporating at 230.

As another illustrative, non-exclusive example, and as also discussed, a portion of the water that is contained within the mine tailings slurry may separate from the mine tailings slurry naturally during the waiting at 230. Thus, the waiting at 230 may permit dewatering of the mine tailings slurry using a smaller mass of water-absorbing polymer than what might be needed in a comparable method that does not include the waiting at 230. Illustrative, non-exclusive examples of threshold settling times according to the present disclosure include threshold settling times of at least 1 hour, at least 2 hours, at least 4 hours, at least 8 hours, at least 12 hours, at least 18 hours, at least 1 day, at least 1.5 days, at least 2 days, at least 3 days, at least 4 days, at least 5 days, at least 6 days, at least 7 days, at least 8 days, at least 9 days, or at least 10 days. Additional illustrative, non-exclusive examples of threshold setting times include times that are greater than 1 day and less than 1 month, greater than 1 day and less than 3 weeks, greater than 3 days and less than 2 weeks, greater than 4 days and less than 10 days, or greater than 6 days and less than 9 days.

Distributing the mass of water-absorbing polymer within the mine tailings dewatering site at 240 may include distributing the mass of water-absorbing polymer subsequent to the distributing at 220 and/or prior to the mechanically incorporating at 250. As an illustrative, non-exclusive example, and as discussed, the mass of water-absorbing polymer may include a dry powder and/or a dry particulate. Thus, the distributing at 240 may include broadcasting, dropping, and/or spreading the mass of water-absorbing polymer onto the mine tailings deposit (or an upper surface thereof). As another illustrative, non-exclusive example, and as also discussed, the water-absorbing polymer may be suspended in a fluid carrier to form a polymer suspension. Thus, the distributing at 240 may include spraying and/or flowing the mass of water-absorbing polymer onto the mine tailings deposit (or an upper surface thereof).

Mechanically incorporating the mass of water-absorbing polymer into the mine tailings deposit at 250 may include mechanically incorporating, or mixing, the mass of water-absorbing polymer into the mine tailings deposit in any suitable manner. As an illustrative, non-exclusive example, and as discussed, the mechanically incorporating may include mechanically incorporating with a mechanical incorporation device, illustrative, non-exclusive examples of which are discussed herein. As another illustrative, non-exclusive example, the mechanically incorporating may include mud farming. As additional illustrative, non-exclusive examples, the mechanically incorporating also may include agitating the mine tailings deposit, disking the mine tailings deposit, tilling the mine tailings deposit, rototilling the mine tailings deposit, and/or turning the mine tailings deposit.

Performing one or more additional steps at 260 may include performing any suitable additional method steps prior to, during, and/or subsequent to performing a remainder of methods 200. As an illustrative, non-exclusive example, the performing at 260 may include reclaiming, reusing, and/or recycling the water-absorbing polymer using methods 400, which are discussed herein. Under these conditions, the mine tailings disposal site of methods 200 may include and/or be a temporary mine tailings disposal site and/or may form a portion of and/or may be associated with a separation assembly that may be utilized during methods 400.

As another illustrative, non-exclusive example, the performing at 260 also may include adding one or more additional additives to the mine tailings slurry and/or to the mine tailings deposit. This may include adding the one or more additional additives prior to the distributing at 220, concurrently with the distributing at 220, subsequent to the distributing at 220, prior to the distributing at 240, concurrently with the distributing at 240, subsequent to the distributing at 240, prior to the mechanically incorporating at 250, concurrently with the mechanically incorporating at 250, and/or subsequent to the mechanically incorporating at 250. Illustrative, non-exclusive examples of additional additives according to the present disclosure are discussed in more detail herein. As yet another illustrative, non-exclusive example, the performing at 260 also may include crosslinking the water-absorbing polymer within the mine tailings deposit, which is also discussed in more detail herein.

FIG. 4 is a flowchart depicting methods 300 according to the present disclosure of forming an encapsulated water-absorbing polymer that may be utilized to dewater a mine tailings slurry that includes mine tailings and water. Methods 300 may include determining a density of the mine tailings at 310 and/or determining a density of a water-absorbing polymer at 320. Methods 300 include selecting a coating material that is configured to encapsulate the water-absorbing polymer to form the encapsulated water-absorbing polymer at 330, selecting a thickness for the coating material within the encapsulated water-absorbing polymer at 340, and encapsulating the water-absorbing polymer in the coating material to form the encapsulated water-absorbing polymer at 350.

Determining the density of the mine tailings at 310 and/or determining the density of the water-absorbing polymer at 320 may include determining the density in any suitable manner. As illustrative, non-exclusive examples, the determining at 310 may include measuring the density of the mine tailings, obtaining the density of the mine tailings (such as from any suitable tabulation of mine tailings densities) and/or receiving the density of the mine tailings from any suitable information source. As additional illustrative, non-exclusive examples, the determining at 320 may include measuring the density of the water-absorbing polymer, obtaining the density of the water-absorbing polymer (such as from a tabulation of water-absorbing polymers densities) and/or receiving the density of the water-absorbing polymer from any suitable information source.

Selecting the coating material at 330 may include selecting any suitable coating material, illustrative, non-exclusive examples of which are discussed herein. As illustrative, non-exclusive examples, the selecting at 330 may include selecting a water-soluble coating material and/or selecting a coating material that will degrade after, during, and/or responsive to contact with water. This may include selecting the coating material to degrade subsequent to contact with water for at least a threshold isolation time, illustrative, non-exclusive examples of which are discussed herein. As another illustrative, non-exclusive example, the selecting at 330 may include selecting the coating material based, at least in part, on the density of the coating material and/or the density of the mine tailings. This may permit matching of a density of the encapsulated water-absorbing polymer to the density of the mine tailings, as discussed herein with reference to the encapsulating at 350.

Selecting the thickness for the coating material at 340 may include selecting any suitable thickness for the coating material based upon any suitable criteria. As an illustrative, non-exclusive example, the coating material may degrade upon contact with water at a coating material degradation rate, and the selecting at 340 may include selecting such that, subsequent to contact between the encapsulated water-absorbing polymer and water, the coating material fluidly isolates the water-absorbing polymer from the water for at least the threshold isolation time. As another illustrative, non-exclusive example, the selecting at 340 may include selecting the thickness for the coating material based, at least in part, on the density of the coating material and/or the density of the mine tailings slurry. This may permit matching of the density of the encapsulated water-absorbing polymer to the density of the mine tailings, as discussed herein with reference to the encapsulating at 350.

Encapsulating the water-absorbing polymer in the coating material at 350 may include coating, covering, surrounding, and/or encapsulating the water-absorbing polymer in the coating material such that the coating material fluidly isolates the water-absorbing polymer, at least temporarily, from a fluid environment that surrounds the water-absorbing polymer. This may include encapsulating the water-absorbing polymer with the coating material that was selected during the selecting at 330 and defining a thickness, or average thickness, of the coating material that is based upon the thickness that was selected at 340. As an illustrative, non-exclusive example, the encapsulating at 350 may include encapsulating such that, subsequent to fluid contact between the encapsulated water-absorbing polymer and water, the coating material fluidly isolates the water-absorbing polymer from the water for at least the threshold isolation time.

As another illustrative, non-exclusive example, methods 300 may include performing the selecting at 330, the selecting at 340, and/or the encapsulating at 350 such that a ratio of the density of the encapsulated water-absorbing polymer to the density of the mine tailings slurry is less than a threshold value. Illustrative, non-exclusive examples of threshold values according to the present disclosure, which also may be referred to herein as a threshold density ratios, include threshold values of less than 1.25, less than 1.2, less than 1.15, less than 1.1, less than 1.08, less than 1.06, less than 1.04, or less than 1.02. Additionally or alternatively, the threshold value also may be greater than 0.75, greater than 0.80, greater than 0.85, greater than 0.90, greater than 0.92, greater than 0.94, greater than 0.96, or greater than 0.98.

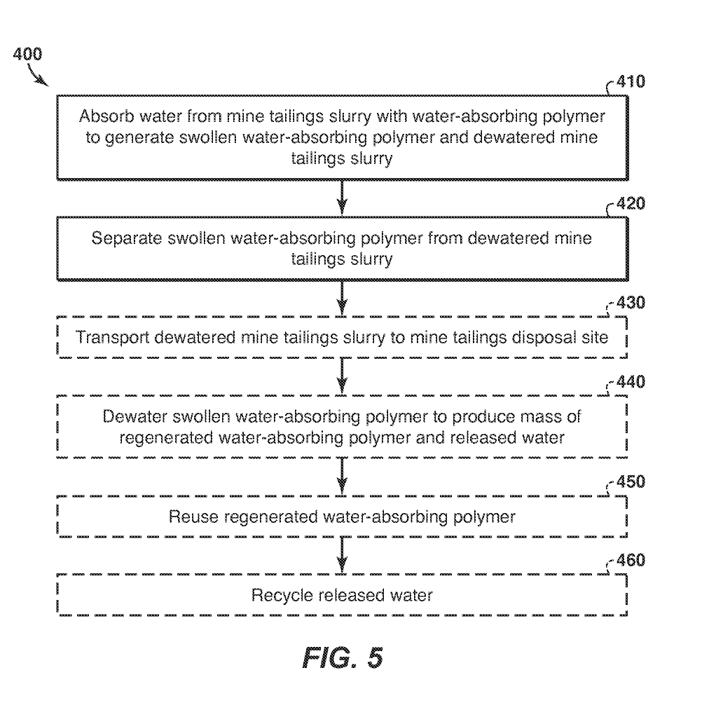

FIG. 5 is a flowchart depicting methods 400 according to the present disclosure of reclaiming, reusing, and/or recycling a water-absorbing polymer. Methods 400 include absorbing, at 410, water from a mine tailings slurry with a mass of water-absorbing polymer that is present within and/or mixed with the mine tailings slurry to generate a mass of swollen water-absorbing polymer and a dewatered mine tailings slurry. Methods 400 further include separating the mass of swollen water-absorbing polymer from the dewatered mine tailings slurry at 420. Methods 400 further may include transporting the dewatered mine tailings slurry to a mine tailings disposal site at 430, dewatering the swollen water-absorbing polymer to produce a mass of regenerated water-absorbing polymer and released water at 440, reusing the regenerated water-absorbing polymer at 450, and/or recycling the released water at 460.

Absorbing water from the mine tailings with the mass of water-absorbing polymer at 410 may include absorbing the water with any suitable water-absorbing polymer, illustrative, non-exclusive examples of which are discussed herein. This may include absorbing, or initiating the absorbing, immediately, or at least substantially immediately, subsequent to contact between the water-absorbing polymer and the water. Additionally or alternatively, the absorbing at 410 also may include absorbing subsequent to at least a threshold isolation time, such as when the water-absorbing polymer is an encapsulated water-absorbing polymer and/or includes a coating material. Illustrative, non-exclusive examples of threshold isolation times, coating materials, and encapsulated water-absorbing polymers are discussed in more detail herein.

Separating the mass of swollen water-absorbing polymer from the mine tailings at 420 may include separating the mass of water-absorbing polymer subsequent to the absorbing at 410 and may be based upon any suitable quality, or property, of the water-absorbing polymer, the swollen water-absorbing polymer, and/or the mine tailings. As an illustrative, non-exclusive example, the separating at 420 may include separating based, at least in part, on a density difference between the mass of swollen water-absorbing polymer and the dewatered mine tailings slurry. As another illustrative, non-exclusive example, the separating at 420 may include separating based, at least in part, on a size difference between the mass of swollen water-absorbing polymer and the dewatered mine tailings slurry. As yet another illustrative, non-exclusive example, the separating at 420 may include separating based, at least in part, on a shape difference between the mass of swollen water-absorbing polymer and the dewatered mine tailings slurry.

It is within the scope of the present disclosure that the separating at 420 may be accomplished in any suitable manner. As illustrative, non-exclusive examples, the separating may include physically separating the mass of swollen water-absorbing polymer from the dewatered mine tailings slurry, chemically separating the mass of swollen water-absorbing polymer from the dewatered mine tailings slurry, separating the mass of swollen water-absorbing polymer from the dewatered mine tailings slurry by agitation, and/or separating the mass of water-absorbing polymer from the dewatered mine tailings slurry by filtration.

Transporting the dewatered mine tailings slurry to the mine tailings disposal site at 430 may include transporting the dewatered mine tailings slurry in any suitable manner. As illustrative, non-exclusive examples, the transporting at 430 may include conveying and/or trucking the dewatered mine tailings slurry. A viscosity and/or shear strength of the dewatered mine tailings slurry may be such that it may be difficult and/or costly to pump and/or pipe the dewatered mine tailings slurry to the mine tailings disposal site. However, it is within the scope of the present disclosure that the transporting at 430 also may include pumping and/or piping the dewatered mine tailings slurry to the mine tailings disposal site.

Dewatering the mass of swollen water-absorbing polymer at 440 may include dewatering the mass of swollen water-absorbing polymer subsequent to the absorbing at 410 and/or subsequent to the separating at 420. This may include dewatering to regenerate at least a portion of the mass of water-absorbing polymer and/or to produce the mass of regenerated water-absorbing polymer. Additionally or alternatively, the dewatering at 440 also may include separating, or releasing, water from the swollen water-absorbing polymer to produce, or generate, released water.

It is within the scope of the present disclosure that the dewatering at 440 may be accomplished in any suitable manner. As illustrative, non-exclusive examples, the dewatering at 440 may include dewatering by application of an electric field to the mass of swollen water-absorbing polymer, dewatering by application of pressure to the mass of swollen water-absorbing polymer, dewatering by application of a shear stress to the mass of swollen water-absorbing polymer, dewatering by centrifuging the mass of swollen water-absorbing polymer, dewatering by grinding the mass of swollen water-absorbing polymer, dewatering by heating the mass of swollen water-absorbing polymer, dewatering by freezing the mass of swollen water-absorbing polymer, and/or dewatering by decreasing a humidity in a vicinity of the mass of swollen water-absorbing polymer.

Reusing the mass of regenerated water-absorbing polymer at 450 may be subsequent to the dewatering at 440 and may include reusing the mass of regenerated water-absorbing polymer in any suitable manner. As illustrative, non-exclusive examples, the reusing at 450 may include mixing and/or otherwise combining the mass of regenerated water-absorbing polymer with mine tailings (such as discussed herein with reference to methods 100 and/or methods 200), encapsulating the mass of regenerated water-absorbing polymer with a coating material (such as discussed herein with reference to methods 300), and/or absorbing water from a mine tailings slurry with the regenerated mass of regenerated water-absorbing polymer (such as during the absorbing at 410). As another illustrative, non-exclusive example, the reusing at 450 also may include reconstituting, or controlling a size, shape, and/or size distribution, of the regenerated water-absorbing polymer (and/or of a plurality of regenerated water-absorbing polymer particles that may be defined by the regenerated water-absorbing polymer).

Recycling the released water at 460 may include utilizing, or reusing, the released water in any suitable manner. As an illustrative, non-exclusive example, the recycling at 460 may include providing, or supplying, the released water to a component of a mining operation that is performing methods 400. As another more specific but still illustrative, non-exclusive example, the recycling at 460 may include combining the released water with bitumen ore to generate, or produce, the mine tailings stream.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

Illustrative, non-exclusive examples of systems and methods according to the present disclosure are presented. It is within the scope of the present disclosure that an individual step of a method recited herein, may additionally or alternatively be referred to as a “step for” performing the recited action.

### INDUSTRIAL APPLICABILITY

The systems and methods disclosed herein are applicable to the oil and gas industry.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A method of dewatering a mine tailings slurry, the method comprising:
combining the mine tailings slurry, which includes mine tailings and water, with a water-absorbing polymer, which is encapsulated in a coating material that inhibits water absorption thereby, to generate an augmented mine tailings slurry;
piping the augmented mine tailings slurry through a transfer pipe to a mine tailings dewatering site;
distributing the augmented mine tailings slurry within the mine tailings dewatering site to form a mine tailings deposit; and
initiating water absorption by a mass of water-absorbing polymer subsequent to the piping, wherein the initiating includes degrading the coating material to permit water absorption by the mass of water-absorbing polymer.

2. The method of claim 1, wherein the combining the mine tailings slurry with the water-absorbing polymer includes combining within a thickening assembly, and wherein the method further comprises combining a flocculant with the mine tailings slurry and the water-absorbing polymer within the thickening assembly to generate the augmented mine tailings slurry.

3. The method of claim 2, wherein the thickening assembly is located at least a threshold piping distance of at least 100 m from the mine tailings dewatering site, and further wherein the piping includes piping across the threshold piping distance.

4. The method of claim 1, wherein the combining includes combining within the transfer pipe by injecting the water-absorbing polymer into an injection port of the transfer pipe.

5. The method of claim 1, further comprising selecting at least one property of the coating material based, at least in part, on at least one of a threshold thickening time, a threshold piping time, a threshold distributing time, and a threshold dewatering time.

6. The method of claim 5, wherein the at least one property of the coating material includes at least one of a composition of the coating material and a thickness of the coating material.

7. The method of claim 1, wherein the coating material is selected to fluidly isolate the water-absorbing polymer from the water for a threshold isolation time of at least 0.5 hours and less than 48 hours.

8. The method of claim 1, further comprising waiting for at least a threshold dewatering time subsequent to the distributing and prior to the initiating, wherein the threshold dewatering time is at least 0.5 hours and less than 48 hours.

9. A method of dewatering a mine tailings slurry, the method comprising:
distributing the mine tailings slurry, which includes mine tailings and water, within a mine tailings dewatering site as a mine tailings deposit; and
mechanically incorporating a mass of water-absorbing polymer into the mine tailings deposit subsequent to the distributing to generate an augmented mine tailings slurry.

10. The method of claim 9, wherein the mechanically incorporating includes at least one of agitating the mine tailings deposit, disking the mine tailings deposit, tilling the mine tailings deposit, rototilling the mine tailings deposit, and turning the mine tailings deposit.

11. The method claim 9, wherein, subsequent to the distributing the mine tailings slurry and prior to the mechanically incorporating the mass of water-absorbing polymer, the method further comprises distributing the mass of water-absorbing polymer within the mine tailings dewatering site.

12. The method of claim 9, further comprising waiting at least a threshold settling time of at least 1 hour subsequent to the distributing the mine tailings slurry and prior to the mechanically incorporating the mass of water-absorbing polymer.

13. The method of claim 9, further comprising:
absorbing water from the augmented mine tailings slurry with the mass of water-absorbing polymer to dewater the augmented mine tailings slurry and generate a mass of swollen water-absorbing polymer and a dewatered mine tailings slurry; and
separating the mass of swollen water-absorbing polymer from the dewatered mine tailings slurry subsequent to the absorbing.

14. The method of claim 13, wherein, subsequent to the separating, the method further comprises transporting the dewatered mine tailings slurry to a mine tailings disposal site.

15. The method of claim 14, wherein, subsequent to the separating, the method further comprises dewatering the mass of swollen water-absorbing polymer to produce a mass of regenerated water-absorbing polymer.

16. The method of claim 15, wherein, subsequent to the dewatering the mass of swollen water-absorbing polymer, the method further comprises reusing the mass of regenerated water-absorbing polymer, and further wherein the reusing includes combining the mass of regenerated water-absorbing polymer with the mine tailings slurry and absorbing water from the mine tailings slurry with the mass of regenerated water-absorbing polymer.

17. The method of claim 9, further comprising adjusting a concentration of the water-absorbing polymer within the augmented mine tailings slurry based upon at least one of a property of the mine tailings slurry prior to combination with the mass of water-absorbing polymer, a property the augmented mine tailings slurry, weather, an ambient temperature, a particle size distribution within the mine tailings slurry, a clay content of the mine tailings slurry, a type of clay within the mine tailings slurry, a turbidity of the mine tailings slurry, and a desired shear strength of the mine tailings deposit.

18. The method of claim 9, wherein the mine tailings slurry includes at least one of oil sands tailings, thickened tailings (TT), mature fine tailings (MFT), solvent recovery unit tailings (TSRU), and fluid fine tailings (FFT).

19. The method of claim 9, wherein the mine tailings slurry includes at least 0.05 wt % and less than 15 wt % bitumen.

20. A method of forming an encapsulated water-absorbing polymer to be utilized to dewater a mine tailings slurry that includes mine tailings and water, the method comprising:
selecting a coating material that is configured to encapsulate a water-absorbing polymer to form the encapsulated water-absorbing polymer;
selecting a thickness for the coating material within the encapsulated water-absorbing polymer, wherein at least one of the selecting the coating material and the selecting the thickness is based, at least in part, on a density of the mine tailings slurry and a density of the water-absorbing polymer; and
encapsulating the water-absorbing polymer with the thickness of the coating material to form the encapsulated water-absorbing polymer, wherein a ratio of a density of the encapsulated water-absorbing polymer to the density of the mine tailings slurry is less than a threshold value.

21. The method of claim 20, wherein the threshold value is less than 1.25 and greater than 0.75.

22. The method of claim 21, wherein the water-absorbing polymer defines a plurality of water-absorbing polymer particles that define an average polymer particle size, and further wherein the method includes selecting the average polymer particle size based, at least in part, on a desired water absorption rate by the plurality of water-absorbing polymer particles.

23. The method of claim 21, wherein the water-absorbing polymer defines a plurality of water-absorbing polymer particles that define a particle size distribution, and wherein the method further comprises selecting the particle size distribution based, at least in part, on a desired water absorption rate by the plurality of water-absorbing polymer particles.

24. The method of claim 23, wherein the selecting the particle size distribution includes selecting a multimodal particle size distribution such that the water-absorbing polymer particles that define a first mode of the multimodal particle size distribution absorb water at a first absorption rate that is different from a second absorption rate of the water-absorbing polymer particles that define a second mode of the multimodal particle size distribution.

25. An apparatus for flocculating and dewatering a mine tailings slurry, the apparatus comprising:
a tank body that defines:
an internal volume;
a flocculant inlet for providing a flocculant to the internal volume;
a water-absorbing polymer inlet for providing a water-absorbing polymer to the internal volume;
a mine tailings inlet for providing the mine tailings slurry to the internal volume;
an underflow outlet for removing an underflow from the internal volume; and
an overflow outlet for removing an overflow from the internal volume;
a mine tailings supply system that is configured to provide the mine tailings slurry, which includes mine tailings and water, to the mine tailings inlet;
a flocculant supply system that is configured to provide the flocculant to the flocculant inlet;
a water-absorbing polymer supply system that is configured to provide the water-absorbing polymer to the water-absorbing polymer inlet; and
a mixing structure that is configured to combine the mine tailings slurry, the flocculant, and the water-absorbing polymer within the internal volume of the tank body to generate the underflow, which is discharged from the underflow outlet, and the overflow, which is discharged from the overflow outlet.

26. The apparatus of claim 25, further comprising the water-absorbing polymer, and wherein at least a portion of the water-absorbing polymer is located within the internal volume of the tank body.
